(19) United States
(12) Patent Application Publication
(10) Pub. No.: US 2017/0320199 A1
(43) Pub. Date: Nov. 9, 2017

(54) Locking Indexing Tool

(71) Applicant: Stanley Black & Decker, Inc., New Britain, CT (US)

(72) Inventor: Oaty A. Frye, Waterford, CT (US)

(21) Appl. No.: 15/587,281

(22) Filed: May 4, 2017

Related U.S. Application Data
(60) Provisional application No. 62/331,811, filed on May 4, 2016.

(51) Int. Cl. B25B 23/00

(52) U.S. Cl. CPC B25B 23/0028

(57) ABSTRACT

An indexing tool includes a head selectively rotatably coupled to a handle. A toothed portion of the head communicates with a toothed portion of a catch within the handle. The catch generally moves along an axis of the handle and is biased towards the toothed portion of the head by a bias disposed within a switch within a portion of the handle. The switch is rotatable generally about a central axis, which repositions the bias with respect to the catch, thus firmly orientating the switch in a variety of desirable positions. The switch position alternatively allows the catch to move generally along the central axis of the handle allowing the head to rotate about the couple, or blocks movement of the catch, thus preventing the head from rotating relative to the handle.

This patent application claims priority to U.S. provisional application 62/331,811 filed May 4, 2016 which is hereby incorporated by reference in its entirety.

### FIELD OF INVENTION

The present invention relates generally to flexible jointed tools, and in particular to a locking indexing tool.

### BACKGROUND OF THE INVENTION

Flexible jointed tools are often employed as a method to access areas unobtainable by un-jointed tools. A jointed tool with a plurality of angular positions allows for maximum range of motion and greater accessibility. It is often desirable to lock a flexible tool at a fixed angular position to prevent the flexible joint from freely swinging and risking damage to equipment and preventing injury to personnel. The method of fixing a flexible joint mostly requires a locking mechanism that has several stages, locked, un-locked and ratcheting. Historically a locking flexible joint has been achieved by sets of complicated holes communicating with paired springs requiring extensive manufacturing and difficult assembly. Some conventional tools attempted to simplify the assembly by using the lock release switch as the catch. This method produced unappealing cosmetics while ratcheting and a mechanism prone to binding.

### SUMMARY OF THE INVENTION

An aspect of the present disclosure is a flexible jointed tool with a plurality of angular positions.

In one aspect, there is described a locking tool comprising a first body including a pivot junction, a second body rotationally pivotable to the first body, the second body including a first recess generally parallel to the axis of the second body and between a first pivot arm and a second pivot arm, and a second recess generally perpendicular to the axis of the second body, a catch disposed in the first recess of the second body, the catch operately engagable with the first body and the second body, a switch disposed in the second recess of the second body, wherein the switch includes a recess, a first surface and a second surface oriented such that in a first orientation the first body can traverse a range of angular positions and in a second orientation the first body cannot traverse a range of angular positions, and a bias movably received in the recess of the switch, the bias including an elastic element and an indexing member, the indexing member communicating with the catch in a first position when the switch is in the first orientation and communicating with the catch in a second position when the switch is in the second orientation.

In another aspect, there is described an indexing tool comprising a first body including, a second body rotationally pivotable to the first body and having a distal end, the second body including a first recess generally parallel to the axis of the second body and a second recess generally perpendicular to the axis of the second body, a catch disposed in the first recess of the second body, a switch disposed in the second recess of the second body, wherein the switch includes a recess, a first surface and a second surface oriented such that in a first orientation the first body can traverse a range of angular positions and in a second orientation the first body cannot traverse a range of angular positions, and a bias movably received in the recess of the switch, the bias including an elastic element and an indexing member, the indexing member communicating with the catch in a first position when the switch is in the first orientation and communicating with the catch in a second position when the switch is in the second orientation.

In another aspect, a locking indexing tool comprising a first body rotationally pivotably, a second body, the second body including a first recess generally parallel to the axis of the second body and a second recess generally perpendicular to the axis of the second body, a catch disposed in the first recess of the second body, a switch disposed in the second recess of the second body, wherein the switch includes a recess, a first surface and a second surface configured such that in a first positioning the first body can pivot about a range of angular positions and in a second positioning the first body cannot pivot a range of angular positions, and a bias movably received in the recess of the switch, the bias including an elastic element and an indexing member, the indexing member communicating with the catch in a first position when the switch is in the first orientation and communicating with the catch in a second position when the switch is in the second orientation.

In another aspect, the flexible tool is composed of a first body, a second body rotatable about a pivot disposed on the first body such that the first body and second body are coupled. The second body contains a mechanism to affix the second body in a plurality of angular positions. Disposed within the second body is a catch, a switch and a controlling indexing member disposed in the switch. The switch body contains a first surface and a second surface oriented generally about a central axis of the switch body such that in a first orientation the second body can traverse a range of angular positions and in a second orientation the second body cannot traverse a range of angular positions. The catch contains a first surface and a second surface such that an indexing member disposed within the catch communicates with the first surface in a first orientation and with the second surface in a second orientation to forcibly retaining the rotation of the switch.

The details of one or more implementations are set forth in the accompanying drawings and the description below. Other features will be apparent from the description and drawings, and from the claims.

### BRIEF DESCRIPTION OF DRAWINGS

Features of a locking indexing tool in accordance with one or more embodiments are shown in the drawings, in which reference numerals designate like elements. The drawings form part of this original disclosure in which:

FIG. 1 is a perspective view of an embodiment of a locking flexible tool in accordance with an embodiment of the present disclosure.

FIG. 2 is a partial exploded perspective view of FIG. 1.

FIG. 3 and FIG. 4 are partial cut-away side views of the tool of FIG. 1 in the locked and unlocked positions, respectively.

FIG. 5 and FIG. 6 are partial cut-away top views of the tool of FIG. 1 in the unlocked and locked positions, respectively.

FIG. 7, FIG. 8 and FIG. 9 are partial side views of the tool of FIG. 1 depicting several possible orientations.

FIG. 10 is a partial cut-away side view of one embodiment of a locking indexing tool depicting one variation of the spring placed outside the diameter of the indexing member.

FIG. 11 is a partial cut-away side view of one embodiment of a locking indexing tool depicting one variation of the spring placed inside the diameter of the indexing member.

FIG. 12 is a partial cut-away side view of one embodiment of a locking indexing tool depicting one variation of the spring communicating with a spherical geometry of an indexing member.

FIG. 13 depicts a partial cut-away view of a side of an embodiment of the disclosed locking flexible tool utilizing an E-Shaped indexing member.

FIG. 14 depicts a partial exploded perspective view of the embodiment of FIG. 13.

FIG. 15 and FIG. 16 are partial cut-away top views of the tool of FIG. 13 in the unlocked and locked positions, respectively.

### DETAILED DESCRIPTION OF THE ILLUSTRATED EMBODIMENT(S)

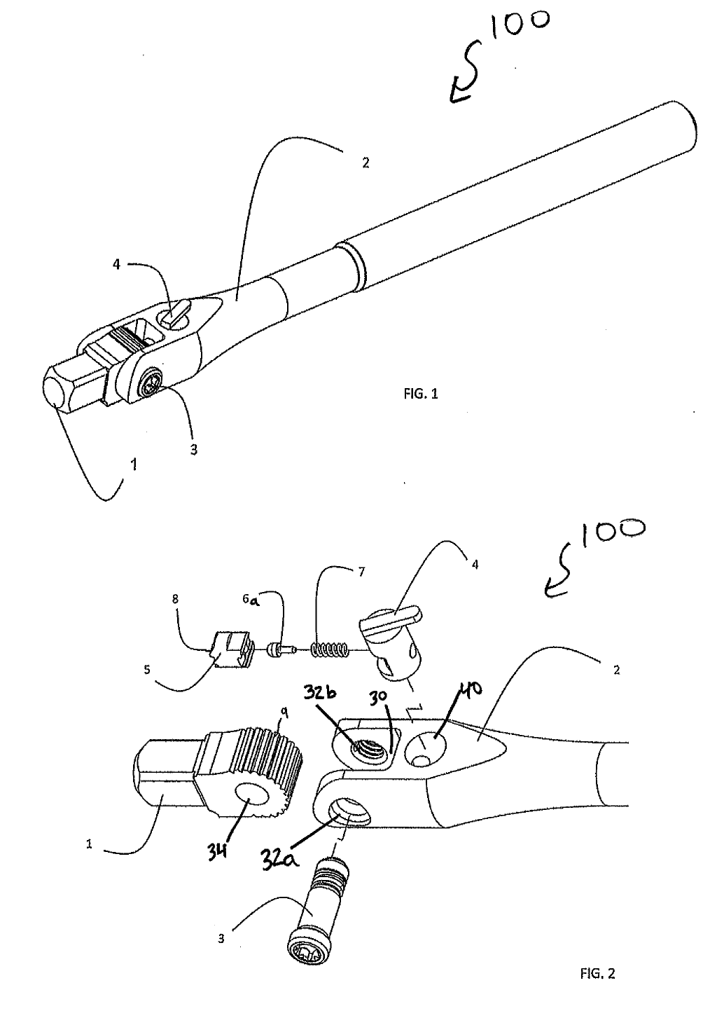

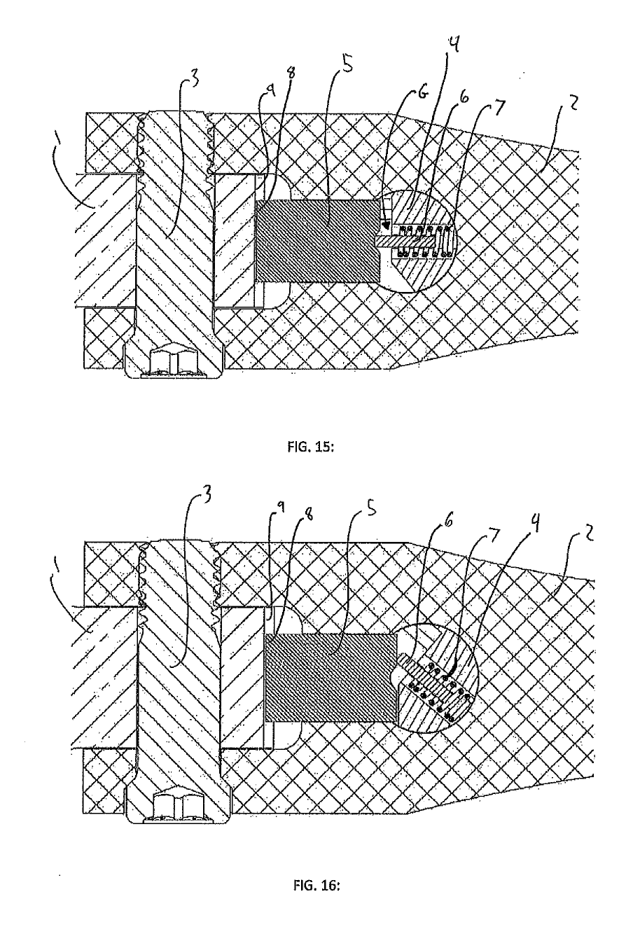

An example implementation of a locking indexing tool 100 is shown in FIGS. 1-16. The example tool 100 illustrated in FIGS. 1-16 is a handheld tool that includes a head that is selectively rotatable, simply for ease of discussion and illustration. However, the principles to be described herein may be applied to other types of indexing tools that is operable in different modes such as, for example, a non-rotating wrench.

As illustrated in FIG. 1 illustrates an isometric view of one embodiment of the locking indexing head tool 100. In the embodiment the first body 1 is coupled to the second body 2 by a pivot shaft 3. The pivot shaft 3 allows the first body 1 to rotate angularly through the longitudinal axis of the second body 2. The first body 1 includes a pivot junction 34 for rotation to the second body 2. A switch 4 is disposed in the second body 2 and pivoting rotationally through a recess in the second body 2. The first body 1 may be, but not limited to: fixed type, ratchet type, or wrench style type of bodies.

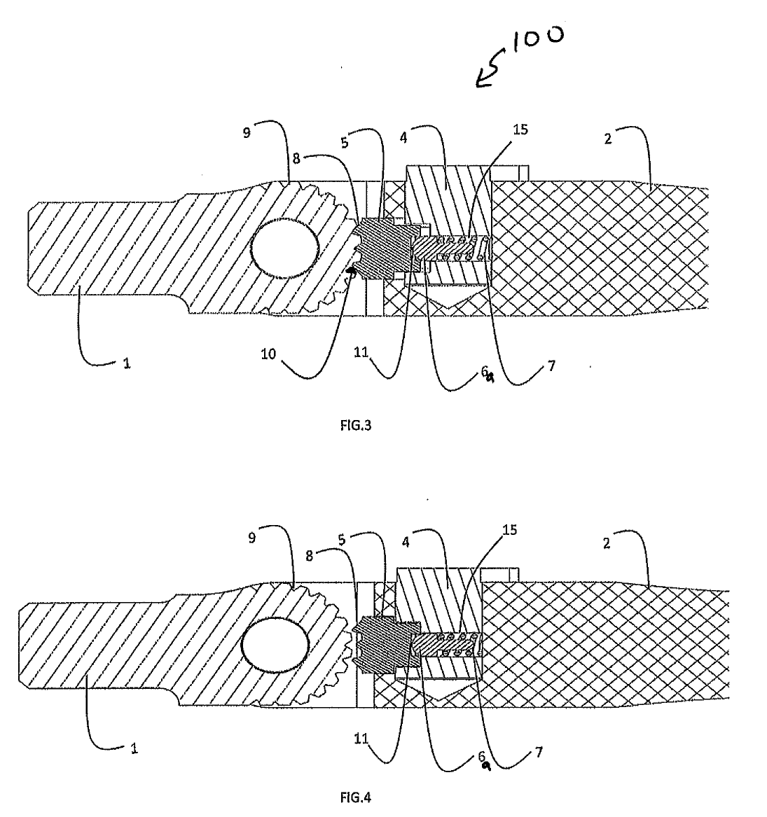

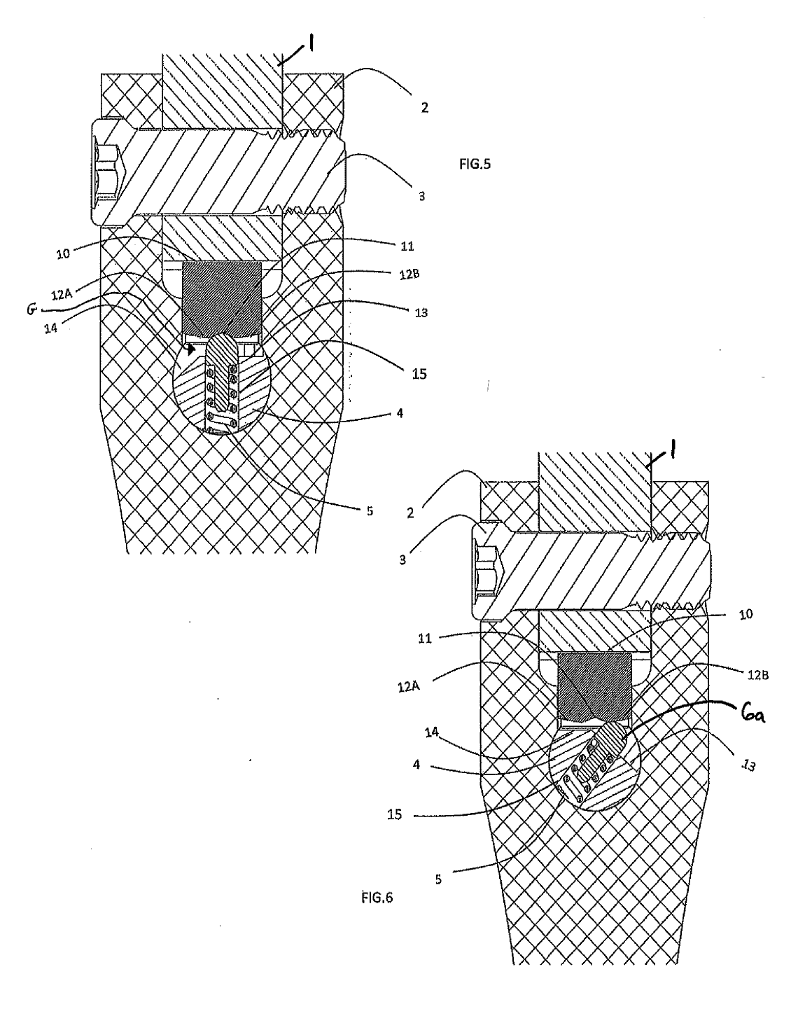

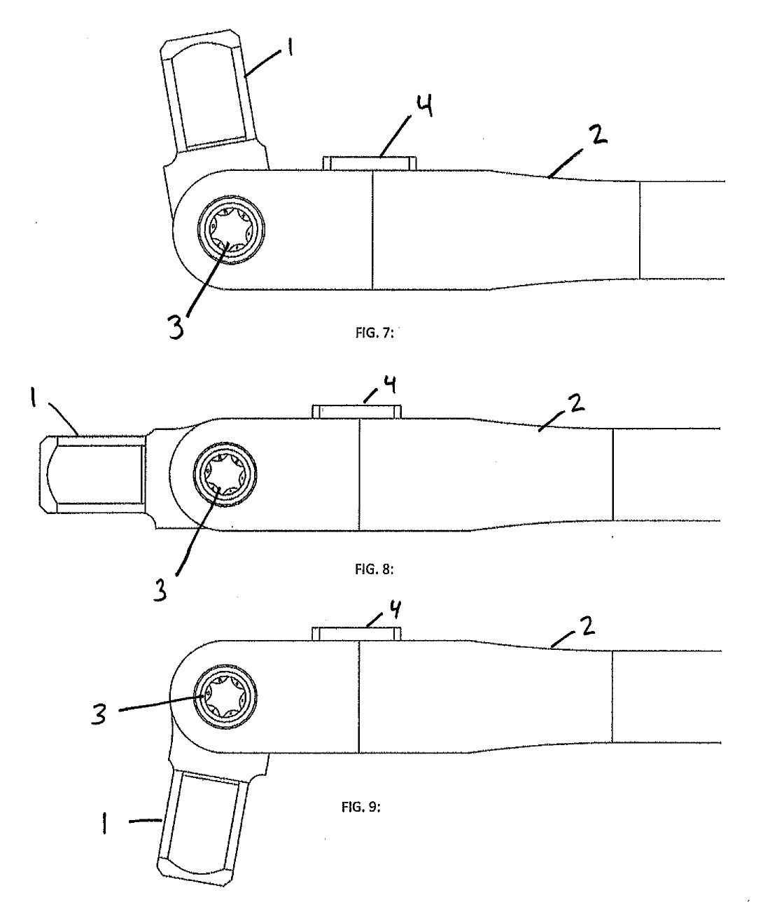

FIG. 2 illustrates an exploded view of the locking flexible head tool 100. In the embodiment the orientations of the switch 4, catch 5, indexing member 6a and spring 7 are shown with respect to their assembly within the second body 2. FIG. 2 also illustrates the first recess 30 in which the pivot shaft 3 can be placed through a first pivot arm 32a and a second pivot arm 32b. The indexing member 6a is disposed within the switch 4 such that the indexing member 6a can be assembled into the switch 4 before the switch 4 is assembled with the second body 2, as shown in FIG. 1. Once assembled, the spring 7 forces the indexing member 6a against catch 5, thus forcing a plurality of teeth 8 on catch 5 to communicate with an exterior toothed surface 9 on the first body 1 as shown generally at 10 in FIG. 3. The switch 4 contains a first surface 13 and a second surface 14. When the switch 4 is generally oriented as in FIG. 5, the catch 5 can longitudinally move generally along the central axis of the second body 2 as shown in FIG. 4, thus allowing the first body 1 to traverse a range of angular motion depicted generally in FIGS. 7, 8 and 9 for pivoting up, neutral and pivoting down, respectively. When the switch 4 is generally oriented as in FIG. 6 the second surface 14 of the switch 4 communicates with the catch 5 generally along the second surface 14 of the switch generally preventing longitudinal movement of the catch 5, thus preventing the first body 1 from traversing a range of angular motion. As switch 4 repositions from as shown in FIG. 5 to as shown in FIG. 6, the indexing member actively translates from a generally neutral position on surface 12, to an alternate position on surface 12B as shown in FIG. 6, thus forcibly orienting the switch 4 in a set position other than a position when the indexing member 6a is communicating with surface 12. Alternatively, surface 12B can be symmetric or asymmetric generally about a central plane of catch 5 with surface 12A and/or continuous with 12, 12A or 12 and 12A.

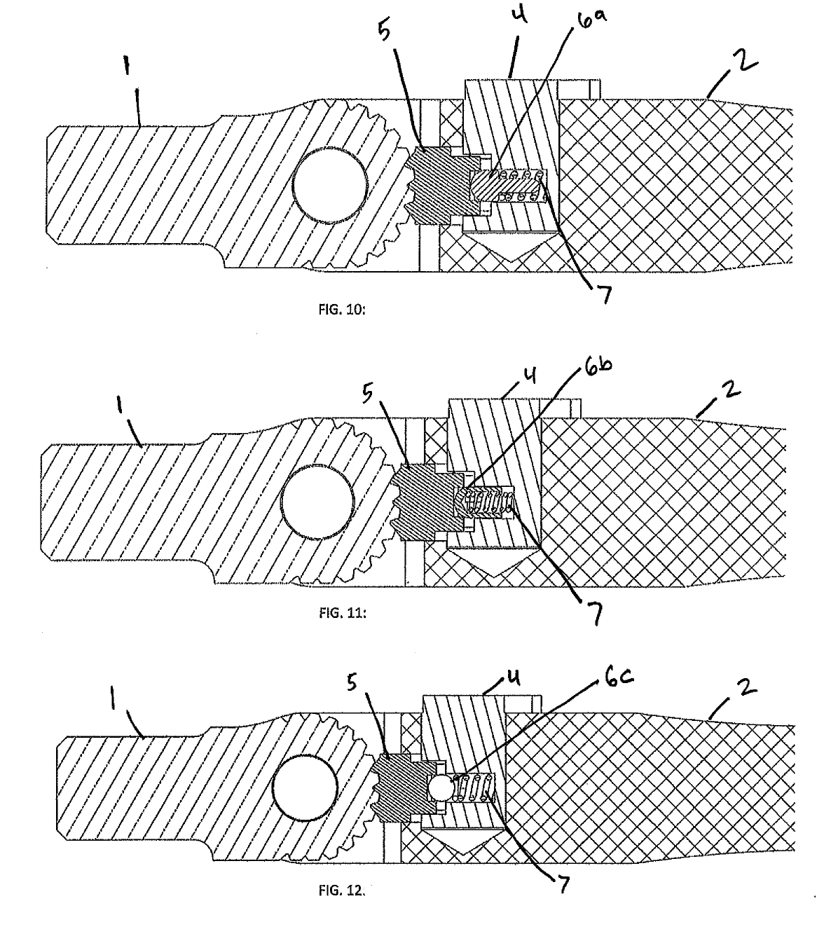

Additionally, the indexing member 6a may communicate with the inner diameter of the spring 7 to engage with the catch 5 as depicted in FIG. 3 and FIG. 10. Alternatively, the indexing member 6b may communicate with the outer diameter of the spring 7 to engage with the catch 5 as depicted in FIG. 11. The indexing member 6c may also be of generally spherical geometry as shown in FIG. 12 to engage with the catch 5. The spring 7 may be disposed in recess 15 which may be the form of, but not limited to the form of a through hole, blind hole or depression in the switch 4.

It may be appreciated that in some embodiments, a benefit of the present disclosure may include a simplified manufacturing of the second body 2 (e.g., with only two simple holes therein). In an embodiment, a simplified assembly, with no springs needed inside the second body 2, may be appreciated. In an embodiment, one can assemble springs into the switch before assembling the switch into the second body, preventing the second body from needing repositioning during assembly. It can be appreciated in an embodiment that the switch might not rotate and shake when repositioning the head. In an embodiment one set of meshing teeth may prevent jamming while trying to transition between locked and un-locked positions.

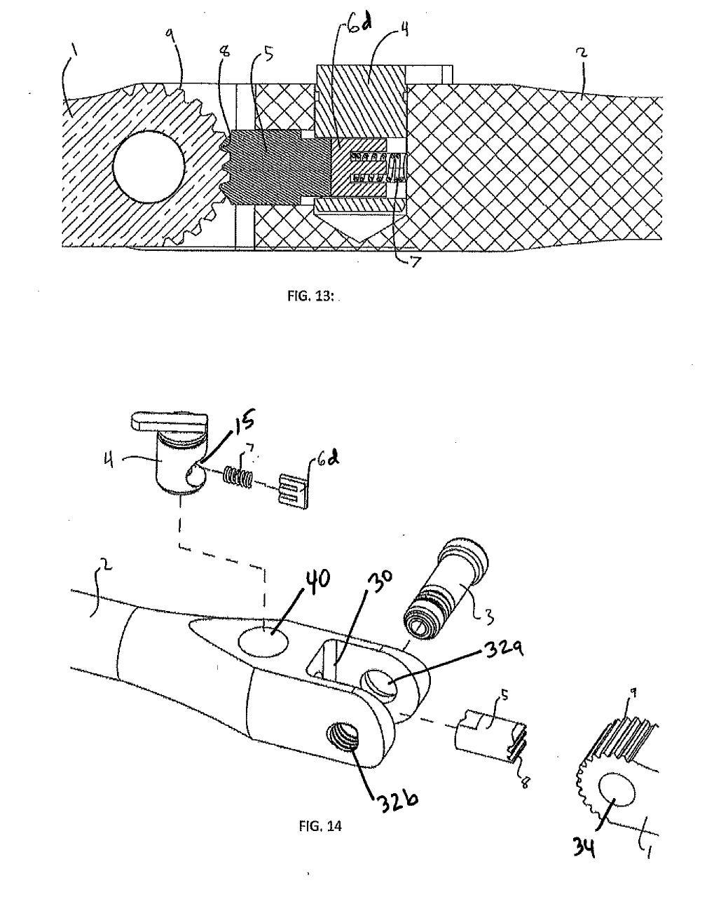

As shown in FIGS. 13-16, and another embodiments the spring 6d may communicate with both the inner diameter and outer diameter of the spring 7. As shown, for example, in an embodiment the indexing member 6d may have an E-shape configuration, where an inner tine of the E-shape may be received inside the spring, while the outer tines of the E-shape surround the spring 7. As illustrated in FIG. 14, the exploded view shows the second recess 40 where the switch 4 including a recess 15 whereby the spring 7 and the indexing member 6d can be contained. FIG. 14 also shows the first recess 30 wherein the indexing member 6d can operately communicate with the catch 5 to allow rotation of the first body 1 through the first pivot arm 32a and the second pivot arm 32b.

As shown in FIG. 15, when the switch 4 is in an unlocked position, a gap G between the catch 5 and the switch 4 facilitates disengagement of the plurality of teeth 8 of the catch 5 and the exterior toothed surface 9 of the first body 1 against the bias of the spring 7, so that the first body 1 may rotate about the pivot 3. When the switch 4 is rotated into a locked position, the gap G is pivoted away from the catch 5, and an abutting surface rotates into place, preventing lateral movement of the catch 5, and locking the first body 1 in the position dictated by the toothed engagement of the plurality of teeth 8 and exterior toothed surface 9.

It may be appreciated that the tools described in the various embodiments herein may be formed of any appropriate material or materials, including but not limited to steel, iron, or other metals, as well as plastics, composites, or so on. Additionally, any individual component described herein may be formed as an assembly of components in various embodiments. Additionally, any assembly of components described herein may be formed as integral components in various embodiments as understood by one of ordinary skill in the art. Aspects of the disclosure are described in the appended claims, while other claims may additionally be supported by this disclosure.

What is claimed is:

1. A locking tool comprising:
a first body including a pivot junction;
a second body rotationally pivotable to the first body, the second body including a first recess generally parallel to the axis of the second body and between a first pivot arm and a second pivot arm, and a second recess generally perpendicular to the axis of the second body;
a catch disposed in the first recess of the second body, the catch operately engagable with the first body and the second body;
a switch disposed in the second recess of the second body, wherein the switch includes a recess, a first surface and a second surface oriented such that in a first orientation the first body can traverse a range of angular positions and in a second orientation the first body cannot traverse a range of angular positions; and
a bias movably received in the recess of the switch, the bias including an elastic element and an indexing member, the indexing member communicating with the catch in a first position when the switch is in the first orientation and communicating with the catch in a second position when the switch is in the second orientation.

2. The locking tool according to claim 1, wherein the pivot junction of the first body includes an exterior toothed surface.

3. The locking tool according to claim 1, wherein the catch includes a plurality of teeth for engaging the exterior toothed surface of the first body.

4. The locking tool according to claim 1, further comprising the catch including a first surface and second surface, and wherein the first surface includes a plurality of teeth for engaging the exterior toothed surface of the first body.

5. The locking tool according to claim 4, wherein the second surface is configured for selectively receiving a bias by the indexing member.

6. The locking tool according to claim 1, further comprising:
the switch including a first surface and a second surface oriented generally about a central axis of the switch such that operation of the switch can selectively apply a force onto the catch for engaging the first body in a plurality of positions.

7. The locking tool according to claim 1, wherein the indexing member is a generally spherical element.

8. The locking tool according to claim 1, wherein the elastic element is received on at least part of an outer diameter of the indexing member.

9. The tool according to claim 1, wherein the elastic element is received within the indexing member.

10. The tool according to claim 1, wherein the indexing member is generally E-shaped.

11. The tool according to claim 9, wherein the indexing member is generally E-shaped.

12. The tool according to claim 10, wherein the elastic element is received within the E-shape of the indexing member, such that an inner tine of the E-shape is received within the elastic element, and outer tines of the E-shape are on opposing sides of the elastic element.

13. An indexing tool comprising:
a first body including;
a second body rotationally pivotable to the first body and having a distal end, the second body including a first recess generally parallel to the axis of the second body and a second recess generally perpendicular to the axis of the second body;
a catch disposed in the first recess of the second body;
a switch disposed in the second recess of the second body, wherein the switch includes a recess, a first surface and a second surface oriented such that in a first orientation the first body can traverse a range of angular positions and in a second orientation the first body cannot traverse a range of angular positions; and
a bias movably received in the recess of the switch, the bias including an elastic element and an indexing member, the indexing member communicating with the catch in a first position when the switch is in the first orientation and communicating with the catch in a second position when the switch is in the second orientation.

14. The indexing tool according to claim 13, wherein the first body includes an exterior toothed surface.

15. The indexing tool according to claim 13, wherein the elastic element is received within the indexing member.

16. The indexing tool according to claim 13, further comprising:
the switch including a first surface and a second surface oriented generally about a central axis of the switch such that operation of the switch can selectively apply a force onto the catch for engaging the first body in a plurality of positions.

17. The indexing tool according to claim 13, further comprising:
wherein the indexing member is generally E-shaped and the elastic element is received within the E-shape of the indexing member, such that an inner tine of the E-shape is received within the elastic element, and outer tines of the E-shape are on opposing sides of the elastic element.

18. A locking indexing tool comprising:
a first body rotationally pivotably;
a second body, the second body including a first recess generally parallel to the axis of the second body and a second recess generally perpendicular to the axis of the second body;
a catch disposed in the first recess of the second body;
a switch disposed in the second recess of the second body, wherein the switch includes a recess, a first surface and a second surface configured such that in a first positioning the first body can pivot about a range of angular positions and in a second positioning the first body cannot pivot a range of angular positions; and
a bias movably received in the recess of the switch, the bias including an elastic element and an indexing member, the indexing member communicating with the catch in a first position when the switch is in the first orientation and communicating with the catch in a second position when the switch is in the second orientation.

19. The locking indexing tool according to claim 18, wherein the elastic element is received within the indexing member.

20. The locking indexing tool according to claim 18, wherein the indexing member is generally E-shaped and the elastic element is received within the E-shape of the indexing member, such that an inner tine of the E-shape is received within the elastic element, and outer tines of the E-shape are on opposing sides of the elastic element.
